(19) United States
(12) Patent Application Publication
(10) Pub. No.: US 2011/0180441 A1
(43) Pub. Date: Jul. 28, 2011

(54) METHOD AND SYSTEM FOR MEDICATION SAFETY

(76) Inventor: Susan L. Bach, Milton, MA (US)

(21) Appl. No.: 12/868,118

(22) Filed: Aug. 25, 2010

Related U.S. Application Data
(60) Provisional application No. 61/236,588, filed on Aug. 25, 2009.

(51) Int. Cl. B65D 90/00; G06F 17/00; H04N 7/18

(52) U.S. Cl. 206/459.5; 235/375; 348/61; 348/E07.085

(57) ABSTRACT

The present invention provides systems, services, and tools for the optimal reduction of medication errors and an increase in the medication adherence for the widest possible audience. In addition, the present invention provides convenient, secure, and fair access to the best possible medication information options. The present invention provides a website that contains multiple video monographs, a suite of other medication safety solutions, including redesigned pharmacy bottles, pharmacy, bags, DVD's, CMI sheets, and the like. In embodiments, the multiple video monographs, a suite of other medication safety solutions, including redesigned pharmacy bottles, pharmacy, bags, DVD's, CMI sheets, and the like may be provided separately.

### CROSS REFERENCE

This application claims the benefit of U.S. Patent Application No. 61/236,588, filed Aug. 25, 2009, the entire disclosure of which is herein incorporated by reference.

### FIELD OF INVENTION

The invention herein disclosed generally refers to medical information, and specifically to increased adherence to proper medication consumption, reduction in medication errors, and increased medication adherence related to increased comprehension of medical information.

### BACKGROUND

Prescription drugs play a vital role in the daily life of people across the world. These prescribed drugs are expected to increase as early preventive treatments play an increasing role under clinical guidelines for any illness.

However, there are ongoing issues with preventable medication errors and medication adherence, which result in major human and financial costs. These errors are related to ineffective communication of medication information. For example, poor readability and comprehension of consumer information often lead to confusion and medication errors among patients. Also, patients who do not take their medications as prescribed are more likely to experience adverse reactions. On a broader level, improper management of chronic disease may result in greater direct healthcare costs arising from preventable hospitalizations or visits to the emergency department. For example, children with asthma are less likely to need emergency care or be hospitalized when they use medications appropriately. Finally, poorly controlled chronic conditions may be associated with lost productivity and other indirect economic costs.

Currently, most consumers receive their prescription drug information from a variety of sources. The first contact may be a “direct to consumer” advertisement. The second point of contact may be when the patient asks about an advertised drug or a physician prescribes a drug in an office visit or hospital setting. Physicians are usually time pressed and hospital settings are harried. The next location the consumer encounters medication information may be at a pharmacy. Generally, state laws require pharmacists to counsel patients if the patient asks for information. However, as is the case with physicians, pharmacists are generally time pressed and often consumers do not ask for information. In any case, oral information is easily forgotten, particularly when in a harried setting and context. The next source of information is the medication package itself, which is comprised of the container itself (generally a pill bottle) and the Consumer Medication Information (CMI) sheet that accompanies the medication package. PPI and labeling varies dramatically among pharmacies, with the most prominent typeface on the bottle often that of the pharmacy itself. Numbers on the bottles are often printed without explanation and color-coded warning stickers are often confusing. Reading instructions on a bottle may be challenging because the bottle may be rotated. Typefaces may be too small to read, especially for elderly consumers.

The pharmacy bag that contains the bottle may provide branding for the pharmacy and may not contain consumer information. The paper CMI, stapled to the bag, may generally contain an entire page of densely worded text in tiny type, and thus may be immediately discarded.

Furthermore, recent FDA studies have shown that fewer than one in 10 of leaflets met criteria for comprehension and legibility. Leaflets for the same drug may range from as few as 33 words to as many as 2,400 words in length, depending upon the pharmacy that distributed the leaflet. Leaflets for the same drug may vary even within a pharmacy chain. The written inserts, CMI, that pharmacies print out for their customers may be from third-party vendors. These third-party vendors may have their own medical advisory boards and may create their own content for the inserts. There is a wide discrepancy in the medication information itself. Also, there is a discrepancy in its distribution.

Many different vendors provide medication information. Pharmacies that use different vendors may offer different information to the public. There is no dissemination of consistent and standardized medication information. The pharmacy may receive the medication information from its vendors and may then distribute this information to its customers. Pharmacies that may want to save paper may print the leaflets using very small fonts making it difficult for consumers to read. In addition, most available CMI online are English only. Consequently, they are of little use to individuals who may not read well or to non-English speakers. Therefore, patients may rely on their memory of a brief office/hospital conversation with their physician or a rushed pharmacy visit to remember how to take their medications. Theoretically, patients may also access the Professional Package Insert (PPI) written by Pharmaceutical companies, approved by FDA and contained in the Physicians' Desk Reference (PDR). PPI information may be highly technical and may be directed at physicians.

Physicians, nurses, pharmacists and caretakers may be confounded by the variety and lack of standardization of patient information materials. As a result, patients may not take their medications properly or stop taking them completely.

In light of the above stated points, there is a need for increased clarity in drug information that may result in increased medication compliance and a reduction in medication errors that together can produce direct health and economic benefits.

### SUMMARY

The present invention provides systems, services, and tools for the optimal reduction of medication errors, and an increase in medication adherence for the widest possible audience. In addition, the present invention provides convenient, secure, and fair access to the best possible medication information options. The present invention provides a website or other monograph delivery platform that contains multiple video monographs, a suite of other medication safety solutions, including redesigned pharmacy bottles, pharmacy bags, DVD's, CMI sheets, and the like. In embodiments, the multiple video monographs, a suite of other medication safety solutions, including redesigned pharmacy bottles, pharmacy bags, DVD's, CMI sheets, and the like that work together as a system and individually.

In an aspect of the invention, a video monograph delivery system may include a server adapted to store, deliver, and play a video monograph, wherein the video monograph is accessible via a unique indicator. The system may be at least one of mobile, desktop, kiosk, OnDemand, DVD, a Memory facility, a TV channel, and a digital storage device attached to a bottle. The indicator may be at least one of a unique code, a bar code, a URL, directions for OnDemand access, a radio frequency identification (RFID) tag, a pill marking, a pill shape, and a pill color. The video monograph may relate to at least one of a pharmaceutical, supplement, a veterinary product, a foodstuff, a cosmetic, a cosmeceutical, and a medical device. The system may further include an electronic medical records facility, wherein when the video monograph is accessed by a user, the user's electronic medical records are updated with a drug prescription. The system may further include a drug interactions database, wherein a user is alerted to a potential drug interaction with other prescriptions stored in the user's electronic medical records. The system may further include an update module, wherein the update module receives monograph updates from a monograph database. The updated module may receive an update, an alert is transmitted to a user.

In an aspect of the invention, a video monograph delivery system may include a server adapted to store, deliver, and play a drug video monograph, wherein the drug video monograph is accessible via a unique indicator. The system may be at least one of mobile, desktop, kiosk, OnDemand, DVD, a Memory facility, a TV channel, a social media page, and a digital storage device attached to a bottle. The indicator may be at least one of a unique code, a bar code, a URL, directions for OnDemand access, an RFID tag, a pill marking, a pill shape, photo, a rendering, and a pill color. The system may further include an electronic medical records facility, wherein when the drug video monograph is accessed by a user, the user's electronic medical records are updated with a drug prescription. The system may further include a drug interactions database, wherein a user is alerted to a potential drug interaction with other prescriptions stored in the user's electronic medical records. The system may further include an update module, wherein the update module receives monograph updates from a monograph database. The updated module may receive an update, an alert is transmitted to a user.

In an aspect of the invention, a housing for an article of manufacture, may include at least one chamber of the housing adapted to store and dispense the article of manufacture, and a digital recording storage facility attached to the housing, wherein the digital recording storage facility is adapted to play a digital recording of information related to the article of manufacture. The article of manufacture may be a pharmaceutical, a veterinary product, a foodstuff, a cosmetic, a cosmeceutical, and a medical device. The digital recording storage facility may also record audio.

In an aspect of the invention, a housing for a pharmaceutical product may include at least one chamber of the housing adapted to store and dispense the pharmaceutical product and a digital recording storage facility attached to the housing, wherein the digital recording storage facility is adapted to play a digital recording of consumer medication information (CMI) related to the pharmaceutical product. The digital recording storage facility can also record audio.

These and other systems, methods, objects, features, and advantages of the present invention will be apparent to those skilled in the art from the following detailed description of the preferred embodiment and the drawings. All documents mentioned herein are hereby incorporated in their entirety by reference.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF FIGURES

The features of the present invention, which are believed to be novel, are set forth with particularity in the appended claims. The invention may best be understood by reference to the following description, taken in conjunction with the accompanying drawings, wherein:

FIG. 1 and FIG. 2 depict a website in English and Spanish version respectively for presenting different video monographs, in accordance with various embodiments of the present invention;

FIG. 3A illustrates a bottle in accordance with various embodiments of the present invention;

FIG. 3B illustrates a pharmacy bag in accordance with various embodiments of the present invention;

FIG. 3C illustrates a CMI sheet in accordance with various embodiments of the present invention;

FIG. 3D illustrates a DVD containing the medication information in accordance with various embodiments of the present invention;

FIG. 4 illustrates another CMI sheet in accordance with various embodiment of the present invention;

FIG. 5 illustrates another CMI sheet in accordance with various embodiments of the present invention;

FIG. 6 illustrates another CMI sheet in accordance with various embodiments of the present invention;

FIG. 7 illustrates a flow diagram explaining the steps associated with the management of distribution of information related to the medication in accordance with various embodiments of the resent invention; and

FIG. 8 illustrates a drug video delivery system in accordance with various embodiments of the present invention.

FIG. 9 illustrates a drug audio CMI delivery system connected to a housing for a pharmaceutical product.

FIG. 10 depicts a safety label of the invention.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention.

### DETAILED DESCRIPTION

While the specification concludes with the claims defining the features of the invention that are regarded as novel, it is believed that the invention will be better understood from a consideration of the following description in conjunction with the drawings figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defied as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

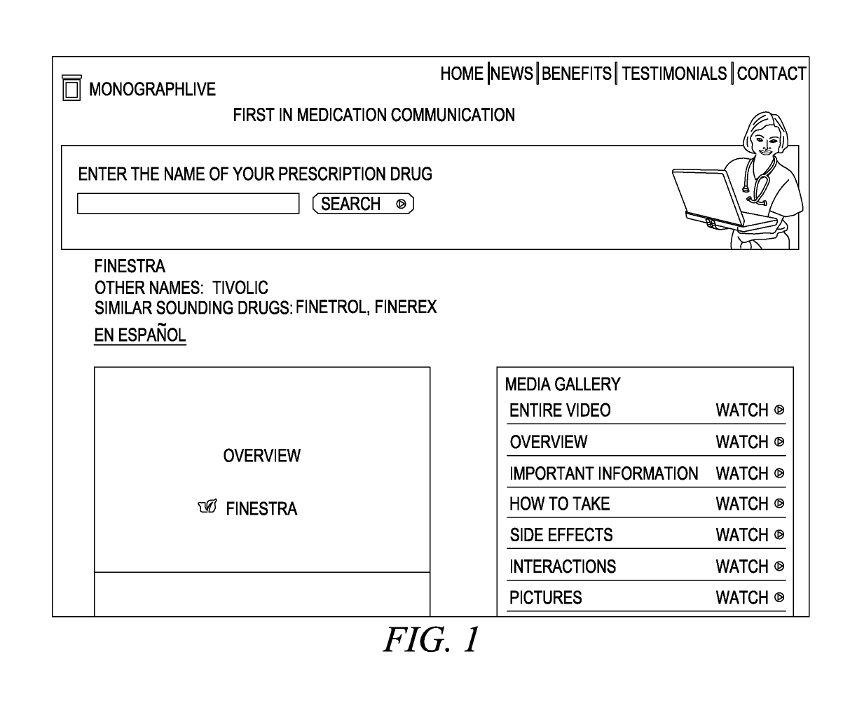

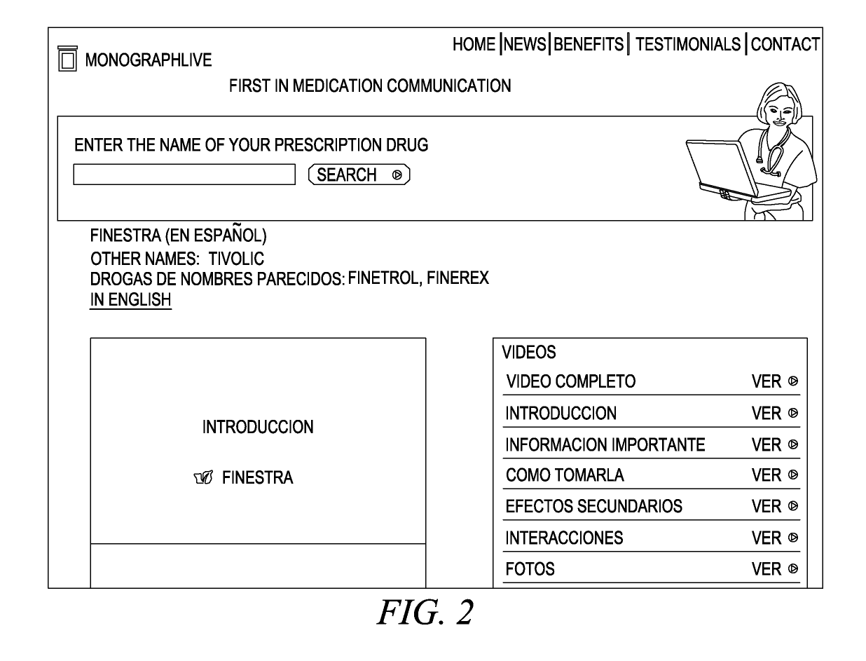

FIG. 1 and FIG. 2 depict a website in English and Spanish version respectively for presenting different video monographs, in accordance with various embodiments of the present invention.

The present invention may provide systems, services, and tools for the optimal reduction of medication errors and an increase in the medication adherence for the widest possible audience through the shown website. In addition, the present invention may provide convenient, secure, and fair access to the best possible medication information options. The present invention provides a delivery platform, such as a website, that contains multiple video monographs, a suite of other medication safety solutions, including redesigned pharmacy bottles, pharmacy bags, DVD's, CMI sheets, and the like. In embodiments, the multiple video monographs, a suite of other medication safety solutions, including redesigned pharmacy bottles, pharmacy, bags, DVD's, CMI sheets, and the like may be provided separately.

The video monographs may contain standardized medication information on specific drugs or therapeutic classes of drugs, foods, medical devices, and the like. These video monographs may provide information which may include, but may not be limited to:
for what condition the medicine was prescribed to treat;
what the medicine is;
why it is needed;
how the medicine works in the body;
why the medicine was selected; the dosage schedule and related instructions about how to take the medicine (before eating, with food, etc);
whether the medicine will work safely with other medicines being taken (both prescription and nonprescription medicines);
what to do if doses are missed or delayed;
the common adverse and side effects that may occur because of a particular medicine and what to do about them;
how to monitor whether the medicine is having its intended effect (are lab tests or blood work necessary; if so, how often);
product description/photo;
how to store and properly dispose of the drug; poison control center number;
a list of similar sounding drugs; a section to download and print the full written monograph;
FDA safety updates;
Contraindications;
Rewards such as compliance points
Ability to access professional information
Ability to notify the FDA;
The date the video was posted (and last updated), and the like.

In addition, the date, time and other information related to the video monograph may be provided. For example, the information related to the updates of the video monographs may also be provided. All the above stated information may be provided in accordance with guidelines from a body overseeing standards and in a standardized form. In some embodiments, no advertisements or promotions may be featured on the monographs or on the website. In embodiments, the video monographs may addresses issues of risk management in drug prescriptions.

In embodiments, these monographs may be uploaded on a website/web-portal. The website may feature short video clips defining dosage and prescribing terms for different medicines, otherwise known as auxiliary labels. For instance, a “do not break” pill monograph may feature why certain pills should not be split in half or in thirds, or the like. In an embodiment, a membership in a program may be required to access the website. For example, if the website is a CVS-branded website, a user of the website may first have to be an EXTRACARE member. In embodiments, the videos may be available on a plurality of third party websites who want to host the videos, such as hospitals, health insurance companies, pharmacies, and the like.

In embodiments, the website may have user-friendly features for the consumer. For example, the consumer may have control over content. Consumers may have the option to view segments of the video related to their needs and in what language they want to view it. In an embodiment, for example, the monograph may be delivered as Braille. They may pick a content style, such as a style directed to a specific population including children, Asians, African Americans, teens, pregnant women, elderly, those of low health literacy, those of high health literacy, and the like. For example, the video may be a doctor giving the information or may be an animated cartoon depicting the instructions, the user may have the option of selecting either the doctor or the animated cartoon. In embodiments, the video monographs may be delivered by well known individuals or celebrities or the patient's own doctor. This may allow them to get what they want quickly and easily without wasting time on irrelevant information. The website may host short length of videos. The length of the entire video may last no more than three minutes and each segment may last 30-35 seconds. This shorter span may ensure the attention of the viewer. Longer videos may be used to explain black box warnings or labeling changes and may be delivered to the user immediately, as opposed to consumers conventionally finding out about the labeling change when they refilled the prescription.

In embodiments, the website may also contain picture of drugs. Pictures of the drugs may be shown so the viewer may know exactly what the medication looks like in case the pharmacist has made a mistake. The web site may also contain the names of similar sounding drugs. Names of similar sounding drugs may be listed in the event the pharmacist has made a prescription error. As shown in FIG. 1 and FIG. 2, the website may be published in Spanish or some other foreign languages. In addition, the website may have a link to an FDA-approved insert, such as the CMI or PPI, so that the consumer may access an unfiltered view of what has been approved by the government.

In embodiments, the website may have a link to videos on medication instructions. The website may offer a link to a selection of short videos that may relate to basic instructions of taking, storing and disposing of medication. In an exemplary scenario, a user may be prescribed a medicine having the instruction “take medication on an empty stomach” or “take with plenty of water”. The user may not know exactly what these phrases mean. The website may have short videos that may clarify these instructions or warnings. The website may have a feedback section, which may gather the feedback as well as post-market events, through surveys and analytics, thereby continually improving its product offering. The feedback may be provided to the FDA. In embodiments, the viewers may be presented with a warning, before the video starts playing. An exemplary warning may be “This video does not take the place of talking with your doctor about your condition or treatment. If you have questions about your medication, ask your doctor or pharmacist.” In embodiments, a location for frequent updates may be provided. For example, the date on which the information is updated may be posted. This may include “black box” warnings. Users may sign up to receive updates and alerts directly. In an embodiment, the drug information may be stored or accessible via a barcode-marked card, or a card with some identification or marking.

In an embodiment, the website may be a social media website, enabling users who have viewed the same monograph or are otherwise interested in drug monographs to connect. In embodiments, a user may sign up to receive reminders regarding the subject of the monograph through the social media website, such as a “TWEET”.

In embodiments, the website may offer users coupons or affinity rewards, such as for viewing an entire video monograph or series of monographs, for compliance with prescribing instructions, and the like. For example, in the embodiment where the website is branded, the coupons or rewards may be associated with the branding entity.

In embodiments, the video monograph delivery platform may be a mobile application. The application may be available on the iPhone, Blackberry, or other mobile device and may be interoperable with other programs. The user may be able to use their mobile device to watch, listen, and read medication information and coordinate reminders.

The video monograph delivery platform may be hosted at a kiosk, such as a kiosk at a pharmacy. For example, upon receiving a prescription, a user may scan a marking, such as bar code or RFID tag, on the pharmaceutical container, blister pack, pharmacy bag, or CMI sheet or enter text, a code, or a URL in order to bring up drug video monographs associated with the prescription at the kiosk or with the imaging function of the mobile device. Alternatively, the user may scan a pill at the kiosk or with the imaging function of the mobile device, and the shape, color, markings, and combinations thereof may uniquely identify the pharmaceutical composition of the pill, such as from a drug photo database, and bring up a video monograph associated with the same. In some embodiments, the kiosk would include an electronic signature box that captures an acknowledgement that the user has viewed the monographs. The acknowledgement may be shared with the pharmacy and other interested third parties, such as insurance providers and electronic medical records providers. In embodiments, the video monograph delivery platform may be a desktop application.

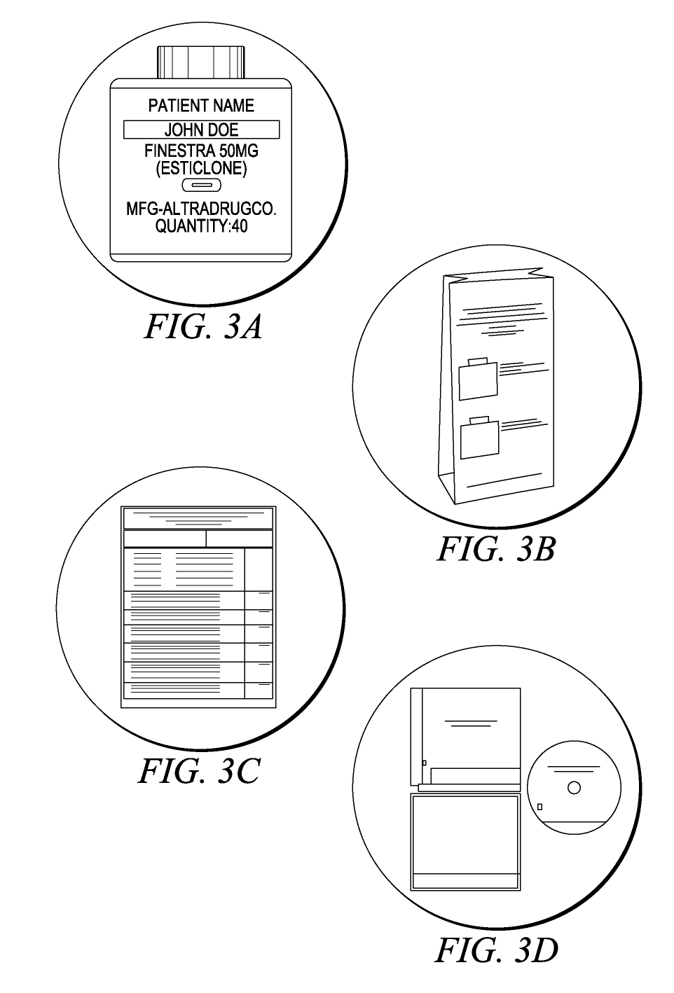

In embodiments, the video monographs described above may also be burned onto media, such as a DVD, a BluRay disc, or other memory facility, such as a memory stick or memory card. The media may be provided directly to patients by doctors' or pharmacists' along with the prescribed drugs. The FDA may recommend or require that certain drugs (a certain therapeutic class of medications or all medications that have black box warnings) be provided to the consumer along with the informational media to facilitate the dissemination and understanding of prescription medication information. The media for the specific drug or the therapeutic class of drug may be an audiovisual presentation and may allow the patient or the caretaker to play the media on the computer or television and watch and listen to the information as well as read the information. An exemplary DVD may be shown in FIG. 3B. For example, the pharmacy may have a DVD burning station and burn DVD's on demand.

In embodiments, the video monograph delivery platform may be on-demand. Instructions for accessing cable or satellite on-demand drug video monographs may be printed on the CMI, bottle or pharmacy bag. In some embodiments, certain broadcast stations may provide video monographs.

In embodiments, the video monograph delivery platform may be accessed via a chip on the label, bottle, CMI sheet, pharmacy bag, media jewel case, cereal box, food packaging, and the like. For example, the chip may be scanned by a scanner or other recognition system in order to access a video monograph on a website, kiosk, and the like. In some embodiments, the chip may be a component of a physical video storage facility integrated with the bottle, jewel case, food packaging and the like.

In embodiments, a mail order prescription may come with instructions on how to access video monographs via a website or on-demand, or media containing the appropriate video monograph may be sent along with the mail order prescription.

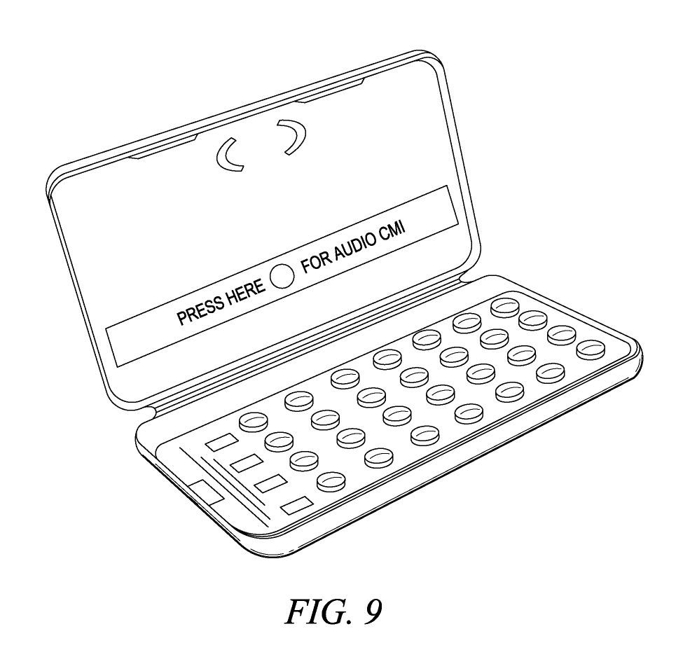

In embodiments, the drug video monograph delivery platform may be incorporated in a housing for an article of manufacture, such as a blister pack of medication, as in FIG. 9. The housing may include a digital recording storage facility attached to the housing, such as with a musical greeting card, wherein the digital recording storage facility is adapted to play a digital recording of information related to the article of manufacture. The article of manufacture may be a pharmaceutical, a veterinary product, a foodstuff, a cosmetic, a cosmeceutical, and a medical device. The digital recording storage facility may come pre-loaded with audio prescribing instructions. The digital recording storage facility may also record audio so that, for example, an individual's doctor may make an on-demand, customized recording of prescribing instructions. Digital recordings would be available in a variety of languages, including but not limited to English and Spanish.

In embodiments, video monographs may be available for any pharmaceutical form, such as pills, tablets, capsules, oral formulations, liquid formulations, syrups, suspensions, powders, crystals, injectables, infusions, parenteral formulations, lozenges, buccal dosage forms, sublingual dosage forms, aerosols, inhalants, nasal formulations, nebulizers, vaporizers, suppositories, topical formulations, creams, ointments, gels, patches, drops, natural medicines, herbs, seeds, and the like.

In embodiments, video monographs may be available for food packaging, veterinary pharmaceuticals, over-the-counter medications, cosmetics, cosmeceuticals, cosmetic devices, medical devices, nutraceuticals, supplements, and the like.

In embodiments, a standardized hard-copy prescription information template, or a re-designed CMI, may accompany each prescription medication that may be dispensed to a consumer. This standardized and uniform template may be easy to read and may allow consumers to easily recognize the condition for which the medications are prescribed, the instructions for consumption (frequency, duration), and any adverse side effects that may accompany the consumption of the medication. The CMI may be two-sided. The CMI may feature a photo of drug. The CMI sheet may be interactive in that if the CMI is accessed on the website, a user may click on a video link in the CMI and be directed to the appropriate drug video monograph. A single CMI sheet may be used for multiple medications. There may be a standardized and uniform template for a professional insert, such as the PPI, as well. In some embodiments, the CMI sheet may have the medication labels on it as well as an advertising space a bar code, and the like.

In embodiments, referring to FIG. 3A, a bottle may be provided. The bottle may be a square bottle with four surfaces that provide room for important information. Each surface may present information in clean standardized format. The fonts and spacing may be used for maximum readability. The cap may be designed to provide a firm grip. The bottle may come with a magnifying tool in order to better read the labels. The bottle may comprise markings related to a standard icon library used to graphically express certain instructions. For example, an icon may be used to symbolize the instruction ‘do not take with grapefruit’. Another icon may be used to symbolize the instruction ‘drink with 8 oz glass of water’. The icons may be explained on the CMI sheet, pharmacy bag, or in a video monograph. In some embodiments, the bottle, CMI sheet, or pharmacy bag may have a phone number for the user to receive information and instructions. The phone number may link to an audio call-in hotline, to a pre-recorded message, to an interactive voice recognition computerized audio system, and the like. The bottle and labels may be designed to facilitate robotic fill.

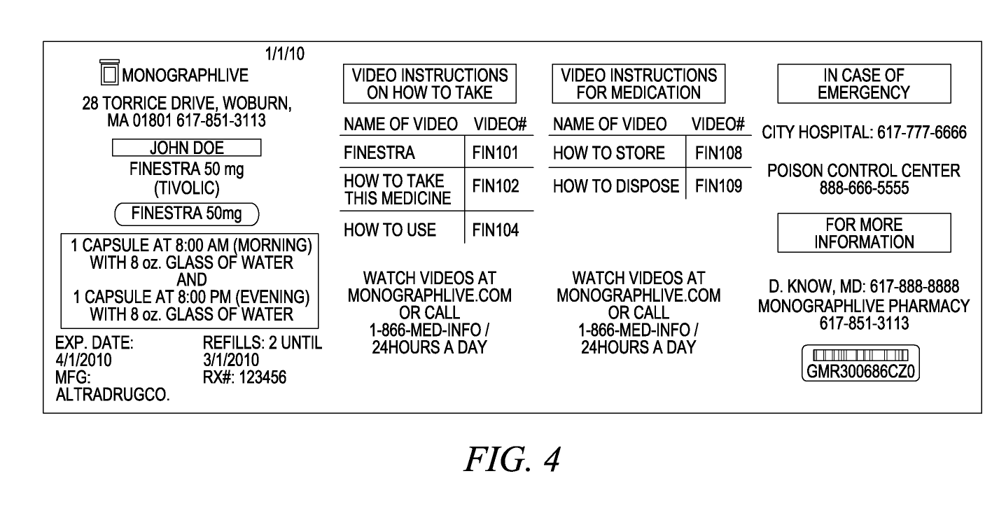

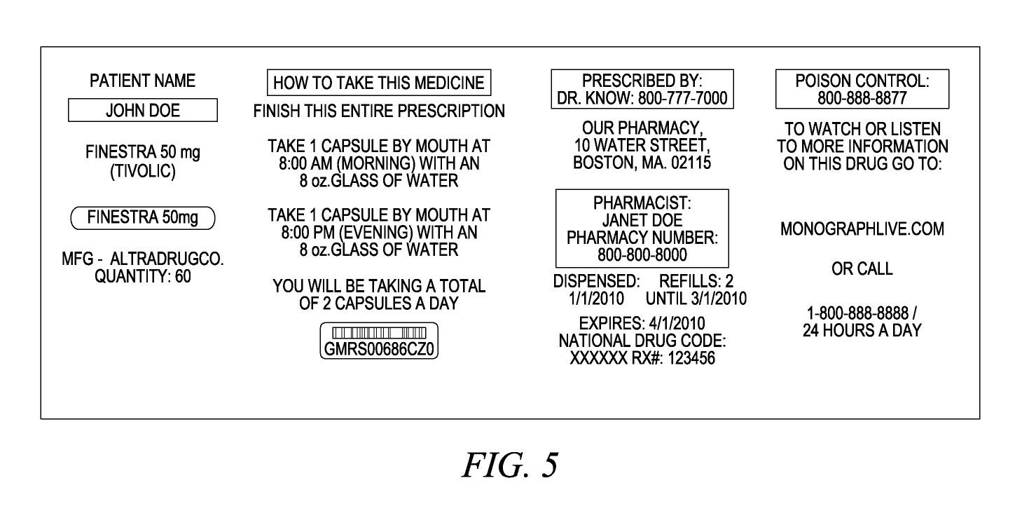

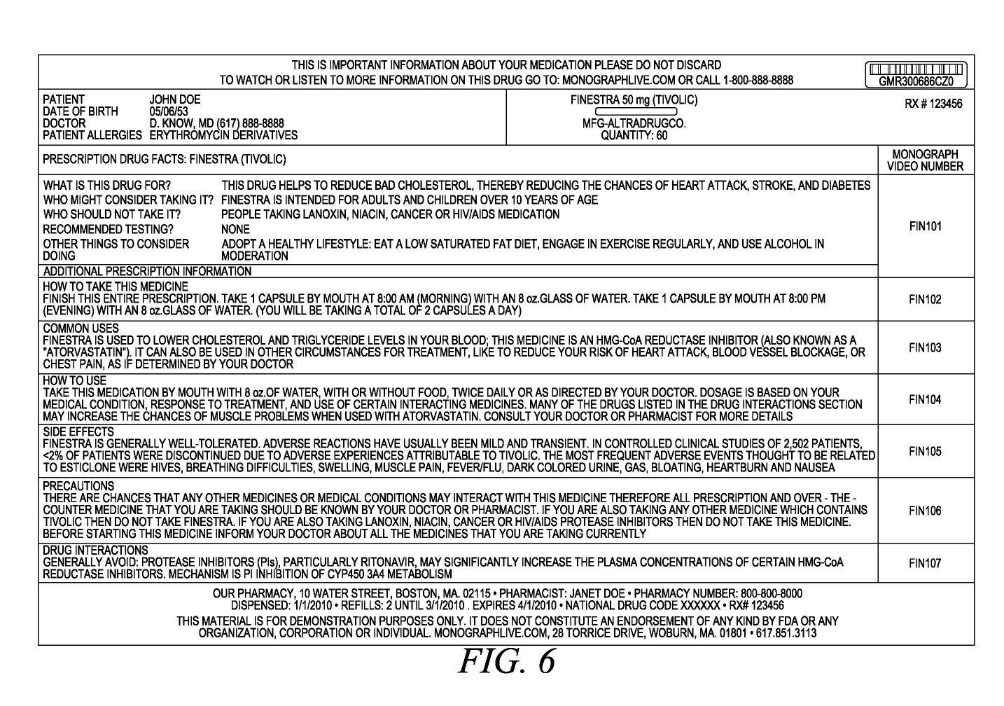

The pharmacy bag, shown in FIG. 3B, that may contain the bottle and the CMI may use the space on the bag to give instructions on the elements of the bottle. The CMI may contain all the elements necessary to meet the FDA requirements. In embodiments, the CMI may include a drug facts box, which may list the facts associated with a certain drug. An exemplary CMI may be shown in FIG. 3C, FIG. 4, FIG. 5, and FIG. 6.

As shown in FIG. 4, a CMI for a drug named “FINESTRA 50 mg (tivolic)” may be provided. The CMI may include the prescription for dosage (“1 capsule at 8:00 AM (morning) with 8 oz. glass of water and 1 capsule at 8:00 PM (evening) with 8 oz. glass of water) may be provided. In addition, the CMI may also include the details of the video monograph, which is present on the web portal or other drug video monograph delivery platform, such as cable-on-demand. For example, the details (such as video number, URL, a bar code and the like) of the video ‘how to take FINESTRA’ may be provided on the CMI. The patient may search the video by inserting the details on the website. In addition, the CMI may contain an emergency number, expiry date, manufacturing date, or some other information. Similarly, other information as shown in FIG. 6 may be present on the CMI. For example, as shown in FIG. 6, information related to FINESTRA such as ‘HOW TO TAKE THIS MEDICINE’, ‘COMMON USES’, ‘HOW TO USE’, ‘SIDE EFFECTS’, ‘PRECAUTIONS’, ‘DRUG INTERACTIONS’, and the like may be provided. In addition, the details of the video segments may be provided on the website for each of the above stated subjects. For example, as shown in FIG. 6, a video number ‘FIN 107’ related to the “Drug Interactions” may be shown. The user may view this video by inserting the number of the video on the website.

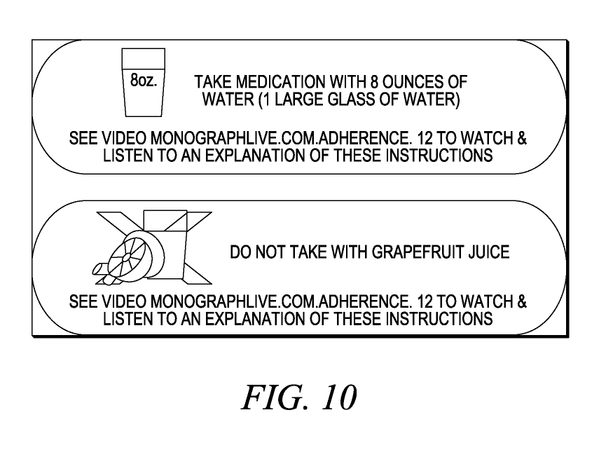

Referring to FIG. 10, a re-designed safety label may be adhered or attached to one or more of the bottle, packaging, pharmacy bag, CMI sheet, or DVD. The safety label may clearly indicate instructions for how to take the medicine as well as an invitation to get more information from the video monograph delivery system.

In embodiments, the video monographs may present a quantum leap for consumers in terms of ease-of use and accessibility of important medication information. Medication information may be accessed from anywhere in the world, any time of day, in virtually any format the consumer chooses to use. In embodiments, there may be no issues of legibility. In embodiments, the video monographs may eliminate the problems caused by font size and legibility associated with the medical information. In embodiments, the monographs may be audio monographs, such as a telephone recording, podcast, and the like. The monographs may be available on demand and may be played on mobile devices. Patients may play the monographs 24/7 from any place in the world. In addition, by referring to an online source, pharmacists may not have to print out the same number of CMI leaflets to its customers. This may help conserve valuable natural resources. In embodiments, the video monographs may increase knowledge retention.

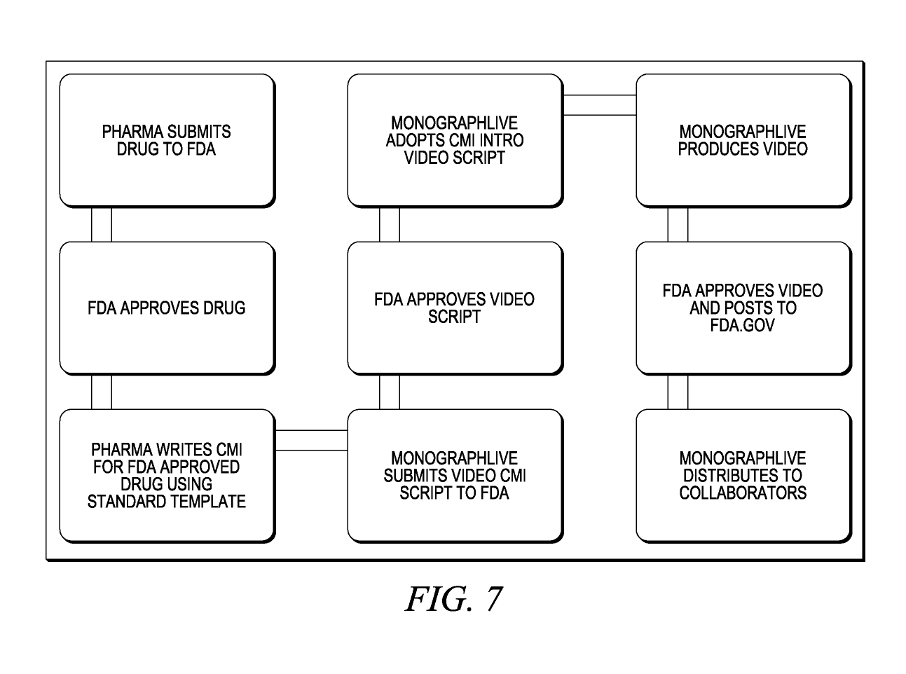

In embodiments, a flow diagram explaining the steps associated with the management of distribution of information related to the medication may be shown in FIG. 7. Firstly, a pharmaceutical company may submit the drug to the FDA. Following this, the FDA may approve the drug. The pharmaceutical company may write CMI for the FDA-approved drug using the standard template of the invention. A video CMI script may be submitted to the FDA for approval. Once the video is produced, the FDA may post the drug video monograph to their website or any of the web portals for distribution to consumers, collaborators, pharmacies, drug manufacturers, hospitals, and the like.

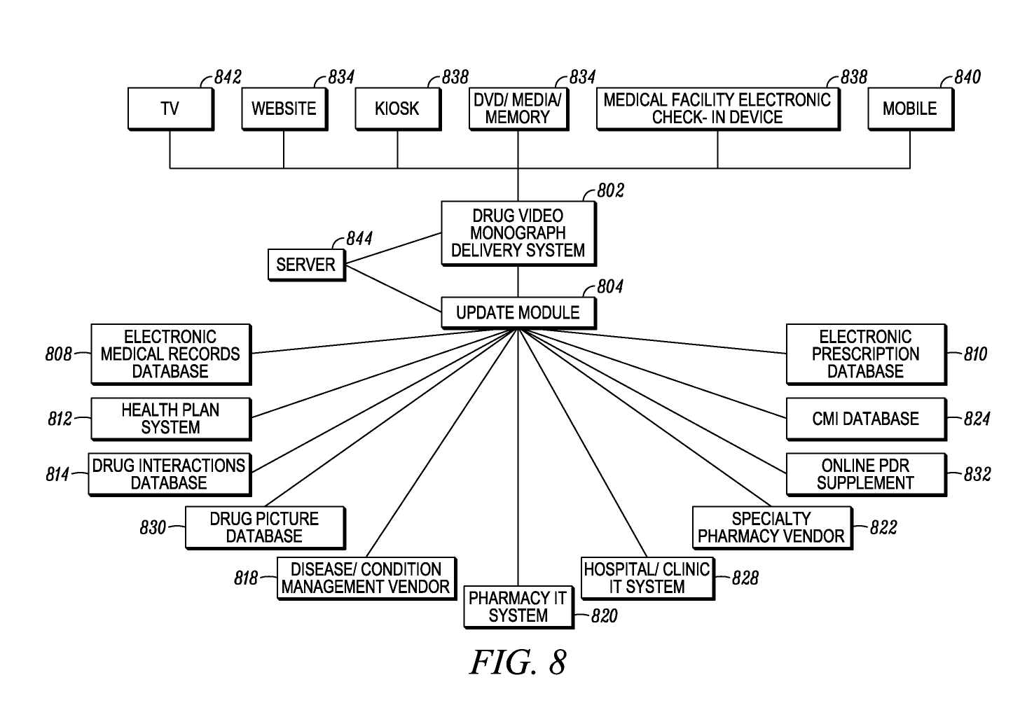

In embodiments, a block diagram of a drug video monograph delivery system 802 may be shown in FIG. 8. The drug video delivery system 802 may include an update module 804. The update module 804 may receive updates from and provide updates to an electronic medical records database 808, an electronic prescription database 810, a health plan system 812, a drug interaction database 814, a condition or disease management vendor system 818, a pharmacy IT system 820, a specialty pharmacy vendor system 822, a CMI database 824, a hospital/clinical IT environment 828, and the like. The electronic medical records database 808 may also link to a drug interactions database 814 and a drug picture database 830. For example, when a new prescription is added or a new pill is scanned and the information is added to the electronic medical records database 808, an alert may come up of an interaction with other medications or known conditions. In an embodiment, the drug video monograph delivery system may be linked to an online PDR supplement 832. All of the interactions among the databases and systems may be undertaken with patient privacy controls. In an embodiment, a patient may have a credit card-type card with a patient specific bar code that would enable access to an electronic medical record or a drug history at a pharmacy, hospital, or the like.

In an embodiment, the drug video monograph delivery system 802 may be accessible from at least one of mobile 840, website/desktop 834, kiosk 838, TV/OnDemand 842, DVD/Media/a memory facility 834, a medical facility electronic check-in device 838, and the like. For example, a medical office may use a touchscreen tablet for electronic check-in. There may be a question on the touchscreen tablet, such as “Do you know to take your meds?” The touchscreen tablet may be adapted to respond by displaying the appropriate drug video monographs on the screen. In an embodiment, the memory facility 834 may be a digital storage device attached to a bottle.

In an embodiment, a video monograph delivery system may include a server 844 adapted to store, deliver, and play a video monograph pertaining to any topic, wherein the video monograph is accessible via a unique indicator. The video monograph delivery system may be an electronic labeling system. The indicator may be at least one of a unique code, a bar code, a URL, directions for OnDemand access, a radio frequency identification (RFID) tag, a pill marking, a pill shape, and a pill color. The video monograph may relate to at least one of a pharmaceutical, supplement, a veterinary product, a foodstuff, a cosmetic, a cosmeceutical, a medical device, and the like.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A video monograph delivery system, comprising:
a server adapted to store, deliver, and play a video monograph,
wherein the video monograph is accessible via a unique indicator.

2. The system of claim 1, wherein the system is at least one of mobile, desktop, a kiosk, OnDemand, a DVD, a Memory facility, a TV channel, and a digital storage device attached to a bottle.

3. The system of claim 1, wherein the indicator is at least one of a unique code, a bar code, a URL, directions for OnDemand access, an RFID tag, a pill marking, a pill shape, and a pill color.

4. The system of claim 1, wherein the video monograph relates to at least one of a pharmaceutical, a veterinary product, a foodstuff, a cosmetic, a cosmeceutical, and a medical device.

5. The system of claim 1, wherein the system further comprises an electronic medical records facility, wherein when the video monograph is accessed by a user, the user's electronic medical records are updated with a drug prescription.

6. The system of claim 5, wherein the system further comprises a drug interactions database, wherein a user is alerted to a potential drug interaction with other prescriptions stored in the user's electronic medical records.

7. The system of claim 1, wherein the system further comprises an update module, wherein the update module receives monograph updates from a monograph database.

8. The system of claim 7, wherein when the updated module receives an update, an alert is transmitted to a user.

9. A drug video monograph delivery system, comprising:
a server adapted to store, deliver, and play a drug video monograph,
wherein the drug video monograph is accessible via a unique indicator.

10. The system of claim 9, wherein the system is at least one of mobile, desktop, kiosk, OnDemand, DVD, a Memory facility, a TV channel, and a digital storage device attached to a bottle.

11. The system of claim 9, wherein the indicator is at least one of a unique code, a bar code, a URL, directions for OnDemand access, an RFID tag, a pill marking, a pill shape, and a pill color.

12. The system of claim 9, wherein the system further comprises an electronic medical records facility, wherein when the drug video monograph is accessed by a user, the user's electronic medical records are updated with a drug prescription.

13. The system of claim 12, wherein the system further comprises a drug interactions database, wherein a user is alerted to a potential drug interaction with other prescriptions stored in the user's electronic medical records.

14. The system of claim 9, wherein the system further comprises an update module, wherein the update module receives monograph updates from a monograph database.

15. The system of claim 14, wherein when the updated module receives an update, an alert is transmitted to a user.

16. A housing for an article of manufacture, comprising:
at least one chamber of the housing adapted to store and dispense the article of manufacture; and
a digital recording storage facility attached to the housing, wherein the digital recording storage facility is adapted to play a digital recording of information related to the article of manufacture.

17. The housing of claim 16, wherein the article of manufacture is a pharmaceutical, a veterinary product, a foodstuff, a cosmetic, a cosmeceutical, and a medical device.

18. The housing of claim 16, wherein the digital recording storage facility can also record audio.

19. A housing for a pharmaceutical product, comprising:
at least one chamber of the housing adapted to store and dispense the pharmaceutical product; and
a digital recording storage facility attached to the housing, wherein the digital recording storage facility is adapted to play a digital recording of consumer medication information (CMI) related to the pharmaceutical product.

20. The housing of claim 19, wherein the digital recording storage facility can also record audio.
